(19) United States
(12) Patent Application Publication
(10) Pub. No.: US 2022/0264058 A1
(43) Pub. Date: Aug. 18, 2022

(54) Device to Capture Video through a Weapon's Iron Sight during Live Fire

(71) Applicant: United States of America, as represented by the Secretary of the Navy, Patuxent River, MD (US)

(72) Inventors: Rocco Portoghese, Winter Park, FL (US); Matthew Adams, Orlando, FL (US); Joseph Vanciel, Orlando, FL (US); Matthew Lankford, Merritt Island, FL (US)

(21) Appl. No.: 17/178,797

(22) Filed: Feb. 18, 2021

(51) Int. Cl. H04N 7/18; F41G 11/00; G02B 23/04

(52) U.S. Cl. CPC H04N 7/185; G02B 23/04; F41G 11/00

(57) ABSTRACT

A device to capture data and video through a weapon's iron sight during live fire, wherein the iron sight has a rear aperture assembly and is able to adjust iron sight elevation. The device includes a beam splitter assembly, a camera, and camera body with a printed circuit board assembly with sensors and a controller, image sensor, device controller and an adjustment arm. The adjustment arm is mountable on the side of the iron sight assembly such that the camera body can be adjusted to the weapon line of sight in a horizontal/windage direction. The beamsplitter assembly splits the light and images to the image sensor and to the shooter's eye without disrupting the shooter's view of a target. The image sensor captures video of the image sent from the beamsplitter assembly. The device controller collects data from all the sensors and sends the data and video to a computer.

### STATEMENT OF GOVERNMENT INTEREST

The invention described herein may be manufactured and used by or for the Government of the United States of America for governmental purposes without payment of any royalties thereon or therefor.

### BACKGROUND

Marksmanship is a foundational skill required of military personnel, enforcement personnel, and any civil servant entrusted with a firearm. Great emphasis is placed upon the acquisition and maintenance of marksmanship skill, especially for military and law enforcement personnel. A marksmanship instructor is a shooter's first and best resource for the acquisition and maintenance of this vital skill. The marksmanship instructor faces many demands upon his/her time and abilities. In modern military and law enforcement firing ranges, each instructor typically oversees multiple students. Time on the firing range and ammunition for training is limited and expensive. Any deficiencies in a particular shooter's performance that require a disproportionate amount of an instructor's time to diagnose and remediate takes instruction away from other trainees. Reshoots and retries consume both valuable time and ammunition. Furthermore, a shooter that cannot demonstrate proper marksmanship at the range quickly enough is in danger of being removed from the firing line and forced to repeat more basic training, incurring yet more expense.

The marksmanship instructor is tasked with teaching his/her students the fundamentals of marksmanship in the safest, quickest and most effective way possible. The Armed Services have identified several marksmanship fundamentals including aiming, breath control, trigger squeeze and steady position. If a shooter is not accurate, he/she is usually deficient in one or more of these fundamentals. However, the root cause of a shooter's poor marksmanship is not always readily apparent even to an experienced instructor. The difficulty and danger of close observation of the shooter at the live fire range, the small physical differences between acceptable and poor weapon handling, and the extremely transient nature of firing events force instructors to very often rely solely on the most heuristic measure of performance available to them: the fall of shot. A poor fall of shot, however, is only the symptom of poor marksmanship. The marksmanship instructor often cannot determine in which fundamental the shooter is lacking solely from their fall of shot. Therefore, marksmanship instructors need something to aid them in monitoring marksmanship fundamentals. Technology that can mitigate these inherent difficulties and expose the root causes of poor marksmanship will increase the marksmanship instructor's efficiency, effectiveness and analytic capability and is consequently of great value to both the instructor and the student.

The Naval Air Warfare Center Training Systems Division (NAWCTSD) recently invented a system to provide a marksmanship instructor with a set of technological tools to allow him/her to more effectively and quickly diagnose and remediate poor shooting at the live fire range. This invention was granted U.S. Pat. No. 10,024,631 on Jul. 17, 2018 (This patent is herein incorporated by reference and is not admitted to be prior art). The invention, among other things, captures video of the sight picture without affecting the shooters view through the sight. The patented system captures aimpoint data through a Rifle Combat Optic currently used by the Marine Corp. However, Army and Law Enforcement trainees are provided primary marksmanship instruction over iron sights. Thus, there was a need for a device that is capable of capturing aimpoint data through an iron sight.

### SUMMARY

The present invention is directed to a method for providing a, with the needs of the method enumerated above and below.

The present invention is directed to a device to capture data and video through a weapon's iron sight during live fire, wherein the iron sight has a rear aperture assembly and is able to adjust iron sight elevation, the weapon having a line of sight. The device includes a camera, camera body, and a beamsplitter assembly. The camera body contains a printed circuit board assembly, image sensor, device controller and an adjustment arm. A camera body adjustment arm is mountable on the side of the iron sight assembly such that the camera body can be adjusted to the weapon line of sight in a horizontal/windage direction. The printed circuit board assembly includes orientation sensors, a shock sensor, an image sensor and a device controller. The beamsplitter assembly splits the light and images to the image sensor and to the shooter's eye without disrupting the shooter's view of a target. The image sensor captures video of the image sent from the beamsplitter assembly. The device controller collects data from all the sensors including the video from the image sensor and sends the data and video to a computer.

It is a feature of the invention to provide a device to capture data and video through a weapon's iron sight during live fire, wherein a shooter's view of the target is not disrupted, obstructed or modified. Furthermore, the device does not affect a shooter's aimpoint and allows normal elevation and windage adjustments.

It is a feature of the invention to provide a device to capture video and data through a weapon's iron sight during live fire, wherein the weapon is not modified and the device may be installed in seconds.

### DRAWINGS

These and other features, aspects and advantages of the present invention will become better understood with reference to the following description and appended claims, and accompanying drawings wherein:

FIG. 1 is a perspective view of the invention;

FIG. 2 is a perspective view of the invention installed on a weapon iron sight and a perspective view of an iron sight assembly;

FIG. 3 is several perspective views of methods of mounting the device on a weapon iron sight;

FIG. 4 is two perspective views of the method of mounting the beamsplitter assembly on a weapon iron sight;

FIG. 5 are several perspective views of the beamsplitter assembly;

FIG. 6 is two perspective views of the invention installed on a weapon iron sight;

FIG. 7 is a perspective view detailing the function of the camera body adjustment arm;

FIG. 8 is an exploded diagram of the camera body, and;

FIG. 9 is a perspective view showing the light path to the shooter's eye when the invention is installed on a weapon.

### DESCRIPTION

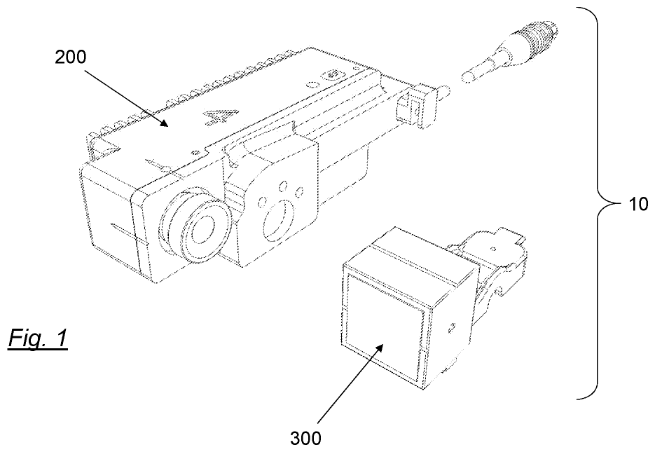

The preferred embodiments of the present invention are illustrated by way of example below and in FIGS. 1-9. In the description of the present invention, the invention will be discussed in a military weapons training environment; however, this invention can be utilized for any type of application that utilizes weapons training.

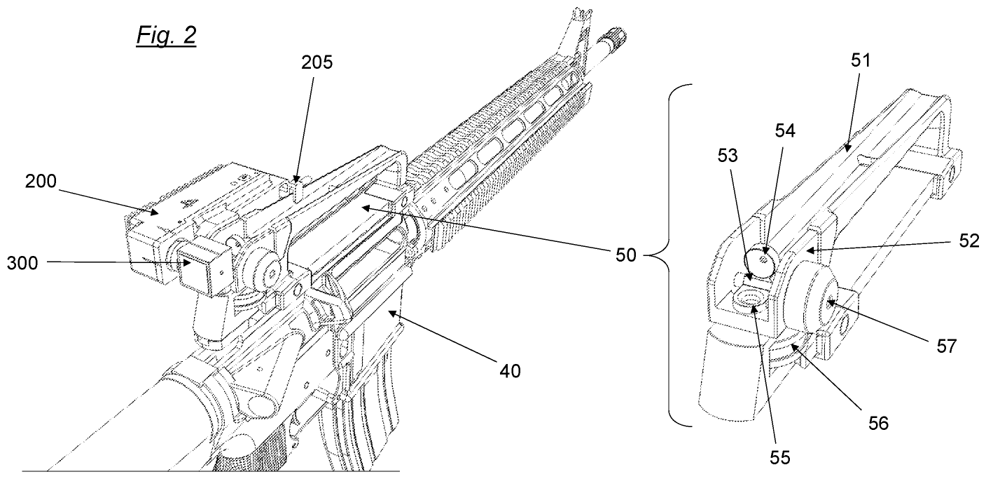

As shown in FIG. 1, the device 10 to capture data and video through a weapon's iron sight includes two major components: a camera body 200 (the camera body includes a camera disposed within the camera body 200) and a beamsplitter assembly 300. In the preferred embodiment, shown in FIG. 2, the camera body 200 and the beamsplitter assembly 300 are attached to the weapon 40 iron sight assembly 50. A detachable iron sight assembly 50 is shown in all figures but the device can just as easily be attached to weapons with integral iron sights. As shown in FIG. 2, the iron sight assembly 50 typically has a body 51 and a rear aperture assembly 52. The rear aperture assembly 52 has a rear peep sight 53 with small peep apertures 54 and large peep apertures 55 as well as elevation adjustment knobs 56 and windage adjustment knobs 57. The camera body 200 mounts to the iron sight rear aperture assembly 52. The camera body 200 has a camera body adjustment arm 205, which is placed over the edge of the iron sight body 51.

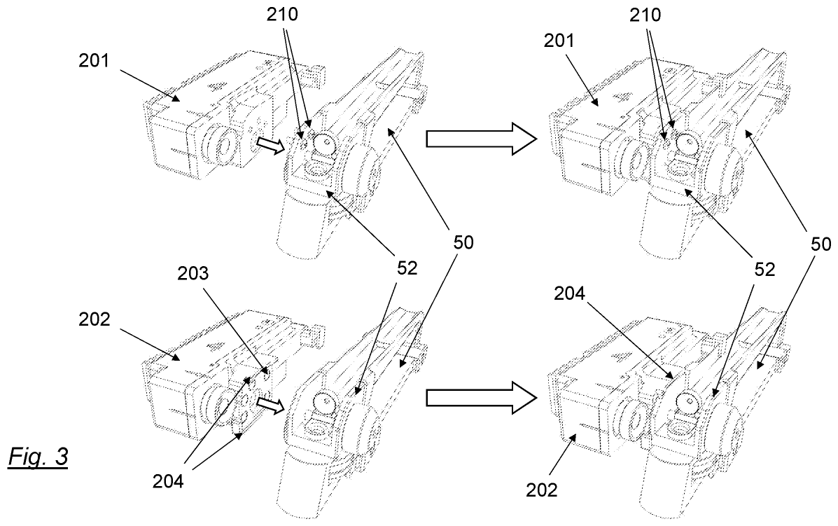

The camera body 200 may be attached to the rear aperture assembly 52 in a multitude of ways, as shown in FIG. 3. In one of the preferred embodiments, a screw-mount version of the camera body 201 may be mounted with machine screws 210 to an iron sight rear aperture assembly 52 in which mounting holes have been drilled. Alternately, a magnet-mount version of the camera body 202 may contain rare-earth magnets 203 and alignment lips 204 that allows it to be temporarily attached to the side of the rear aperture assembly 52 without modification to the iron sight hardware.

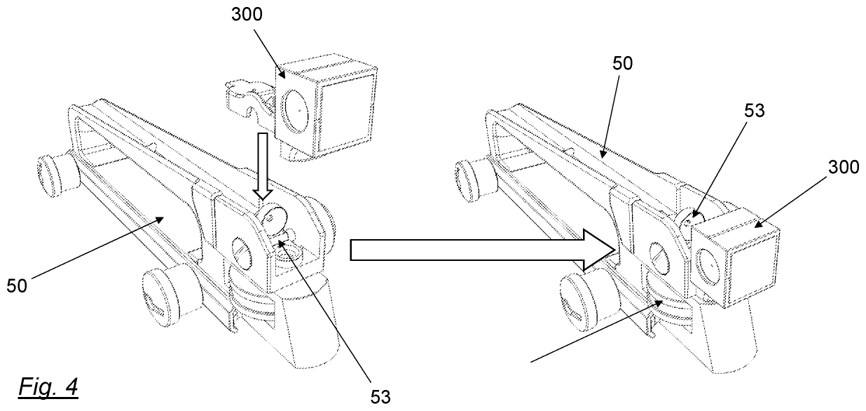

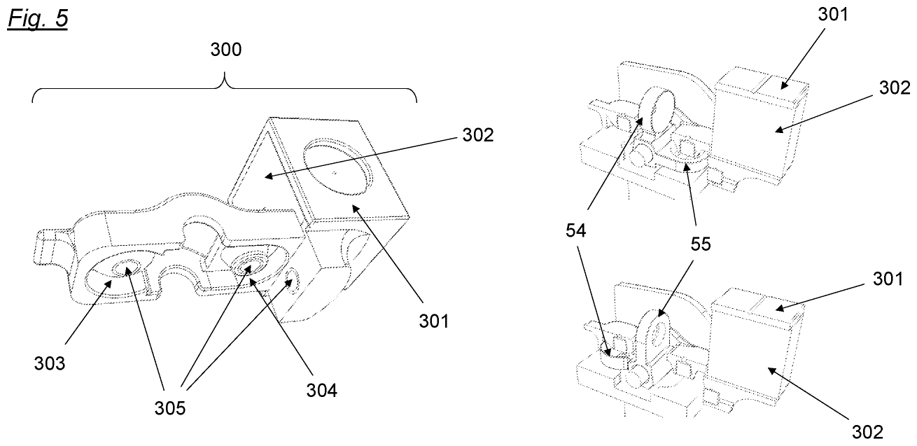

As shown in FIG. 4, the beamsplitter assembly 300 installs over the rear peep sight 53. FIG. 5 shows the beamsplitter assembly 300, which includes a beamsplitter body 301 and a beamsplitter 302. The bottom of the beamsplitter body 301 has small aperture cavities 303 and large aperture cavities 304 that closely match the shape of the small peep apertures 54 and large peep aperture 55, respectively. As shown in the cutaway drawings in FIG. 5, the beamsplitter assembly 300 will fit snugly over the rear peep sight 53 with either rear aperture in the up position. Three beamsplitter rare earth magnets 305 hold the assembly firmly in place on the rear aperture assembly 52.

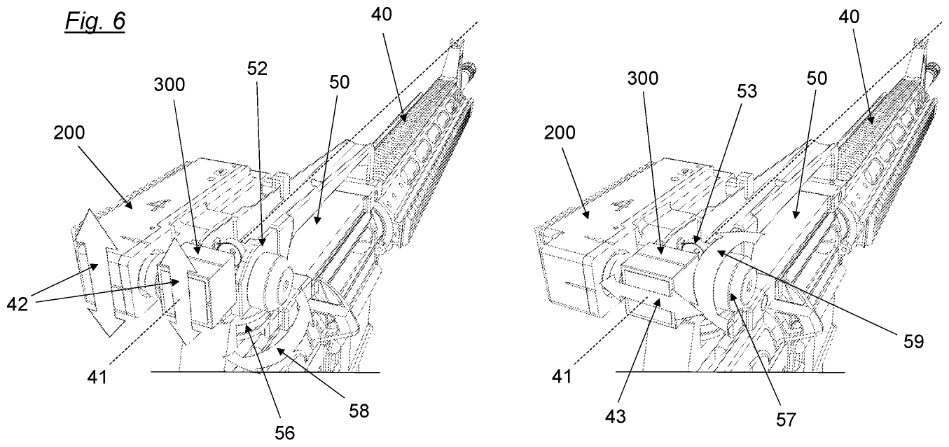

FIG. 6 shows the camera body 200 and beamsplitter assembly 300 mounted to an iron sight 50 on weapon 40 with a line of sight 41. The line of sight 41 is a line passing through the center of the rear peep and over the top of the weapon front post sight, indicating the center of the field of view of a properly placed shooter's eye. The iron sight elevation adjustment knob 56 can be rotated (rotation shown in FIG. 6 by 58) to move the rear aperture assembly 52 up and down, altering the line of sight 41 in the vertical/elevation direction 42. The camera body 200 and the beamsplitter assembly 300 are both mounted onto the iron sight rear aperture assembly 52 and therefore track with changes of line of sight 41 in the vertical/elevation direction 42. The iron sight windage adjustment knob 57 can be rotated (rotation shown in FIG. 6 by 59) to move the rear peep sight 53 left and right, altering the line of sight 41 in the horizontal/windage direction 43. The beamsplitter assembly 300 is mounted directly onto the rear peep sight 53 and therefore tracks changes of line of sight 41 in the horizontal/windage direction 43.

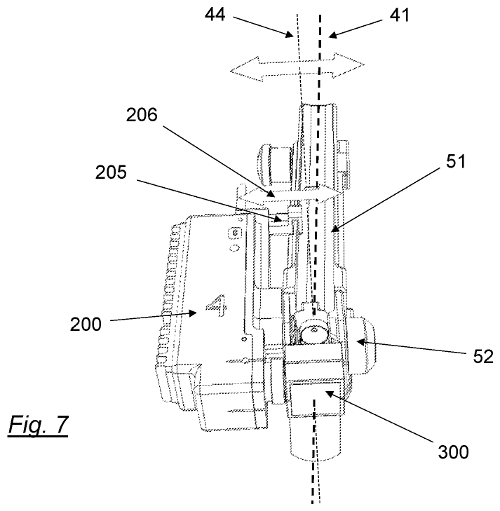

In a typical iron sight assembly 50, in order to allow for adjustment in the vertical/elevation direction, the rear aperture assembly 52 is not rigidly attached to the iron sight body 51. Referring to FIG. 7, the rear aperture assembly 52 line of alignment 44 does not necessarily align with the weapon line of sight 41. The length of the camera body adjustment arm 205 may be changed (directions shown by 206) by means of an integral adjustment screw in order to allow the rear aperture assembly alignment 44 to be moved to match the line of sight 41.

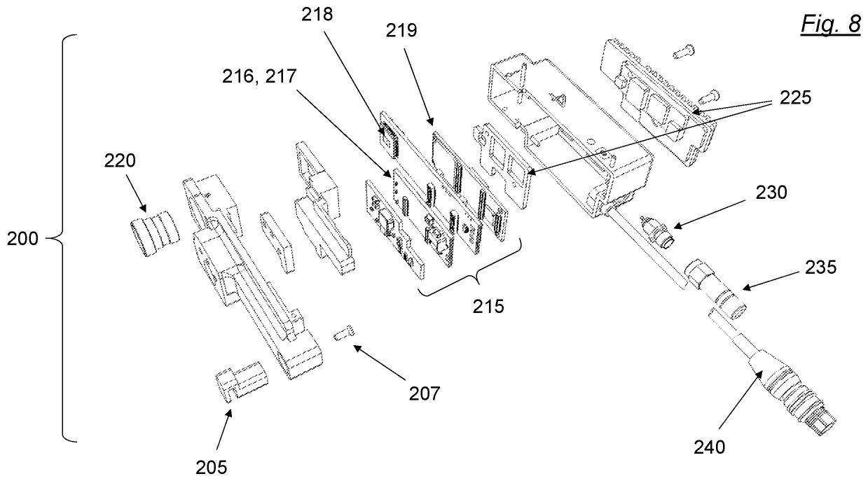

Shown in FIG. 8, the camera body 200 houses the adjustment arm 205, an adjustment arm adjustment screw 207, a printed circuit board assembly 215, an optical lens assembly 220, internal and external heatsinks 225, an antenna connector 230, an antenna 235 and a communication assembly 240. The printed circuit board assembly 215 includes an orientation sensor 216, a shock sensor 217, an image sensor 218, and a device controller 219 with wireless capabilities. The image sensor 218 captures the image sent from the beamsplitter assembly 300 through the optical lens assembly 220. In the preferred embodiment, the image sensor 218 has a resolution of about 3.4 megapixels and can capture up to sixty frames per second. Heatsinks 225 provide cooling for the device controller 219. The communication assembly 240 brings power and sensor data from a separate data collector to the printed circuit board assembly 215. The device controller 219 collects data from the onboard sensors 216, 217 and 218 and external sensors connected through the communication assembly 240 and sends the data wirelessly through the antenna connector 230 and the antenna 235 to a computer.

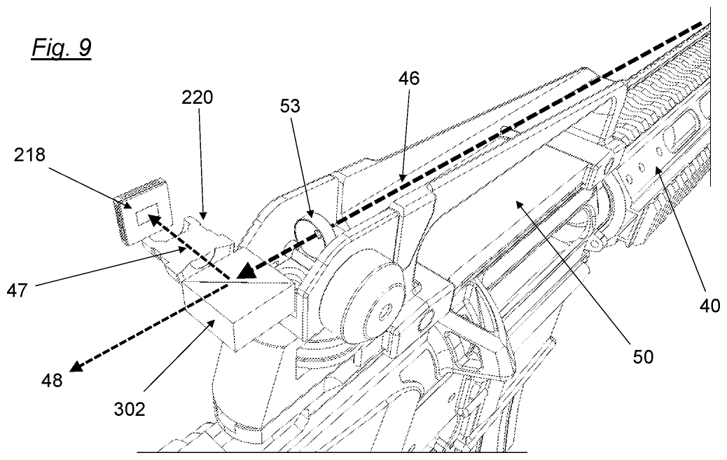

FIG. 9 is a cutaway drawing showing the light path through the optical components contained within the device when installed on the weapon 40. Incident light 46 from the downrange image passes through the rear peep sight 53 and beamsplitter 302. The beamsplitter 302 may be, but without limitation, a cubical commercial optical device that transmits half of the light incident on a face through the body while the balance is reflected out of an adjacent face, splitting the light in two perpendicular directions. However, any type of beamsplitter that is practicable can be utilized. In the preferred embodiment, the beamsplitter 302 splits the light into reflected images 47 and transmitted images 48. The reflected image 47 passes through the optical lens assembly 220, which images the light onto the surface of the image sensor 218 for capture. The transmitted image 48 passes to the shooter's eye without disrupting the shooter's view downrange.

When introducing elements of the present invention or the preferred embodiment(s) thereof, the articles “a,” “an,” “the,” and “said” are intended to mean there are one or more of the elements. The terms “comprising,” “including,” and “having” are intended to be inclusive and mean that there may be additional elements other than the listed elements.

Although the present invention has been described in considerable detail with reference to certain preferred embodiments thereof, other embodiments are possible. Therefore, the spirit and scope of the appended claims should not be limited to the description of the preferred embodiment(s) contained herein.

What is claimed is:

1. A device to capture video and data through a weapon's iron sight during live fire, the iron sight having a rear aperture assembly with a side and is able to adjust iron sight elevation, the weapon having a line of sight, the device comprising:
a camera;
a camera body for housing the camera, the camera body having a camera body adjustment arm and a printed circuit board assembly, the camera body adjustment arm mountable on the side of the iron sight's rear aperture assembly such that the camera body can be adjusted to the weapon's line of sight in a horizontal/windage direction, the printed circuit board assembly includes orientation sensors, shock sensors, and an image sensor;
a beamsplitter assembly for splitting light and images to the camera and to a shooter's eye without disrupting the shooter's view of a target, the camera capturing on video the light and image sent from the beamsplitter assembly;
a data collector that collects data from all the sensors including the video from the camera and is able to send the data and video to a computer.

2. The device of claim, wherein the device further includes a controller with wireless capabilities allowing wireless communication between the data collector and the computer.
